(19) United States
(12) Patent Application Publication
(10) Pub. No.: US 2007/0163437 A1
(43) Pub. Date: Jul. 19, 2007

(54) Hydrogen or helium permeation membrane and storage membrane and process for producing the same

(76) Inventors: Shinichi Ikeda, Ibaraki (JP); Norio Umeyama, Ibaraki (JP); Ariyoshi Ogasawara, Kanagawa (JP); Hideo Abe, Kanagawa (JP); Yasuhito Tanaka, Kanagawa (JP)

Correspondence Address: REED SMITH LLP, 3110 FAIRVIEW PARK DRIVE, SUITE 1400, FALLS CHURCH, VA, 22042, US

(21) Appl. No.: 10/586,311

(22) PCT Filed: Jan. 4, 2005
(86) PCT No.: PCT/JP05/00001

§ 371 Date: Jul. 14, 2006

(30) Foreign Application Priority Data
Jan. 15, 2004 (JP) 2004-038997

(51) Int. Cl. B01D 53/22

(52) U.S. Cl. 96/4

(57) ABSTRACT

A hydrogen permeation membrane that selectively allows the passage of hydrogen and that can be formed in a desired shape is obtained by using a silicon resin that includes at least phenylheptamethylcyclotetrasiloxane and/or 2,6-cis-diphenylhexamethylcyclotetrasiloxane. A heat-resistant coating that is resistance to temperature of 300° C. or higher is obtained in a sintering process at temperature of 200° C. to 500° C., thereby providing a hydrogen or helium permeation membrane that has excellent water resistance. Similarly, a hydrogen or helium storage membrane that selectively stores hydrogen and that can be formed in a desired shape can be formed by using a silicon resin that includes at least phenylheptamethylcyclotetrasiloxane and/or 2,6-cis-diphenylhexamethylcyclotetrasiloxane. A heat-resistant coating that is resistance to temperature of 300° C. or higher is obtained in a sintering process at temperature of 200° C. to 500° C., thereby providing a hydrogen or helium storage membrane that has excellent water resistance.

### TECHNICAL FIELD

The present invention relates to hydrogen permeation membrane used mainly in electrolytic capacitors, fuel cells, the purification of hydrogen, and solar cell systems. The invention also relates to hydrogen storage membrane used for the storage and transport of energy via the fuel tank of a hydrogen vehicle or a chemical heat pump. The invention also relates to a method for the production of such membranes.

### BACKGROUND ART

Several processes are known for the production of hydrogen, such as processes involving the breakdown of water, ammonia, and methanol, and the steam reforming of hydrocarbon gas. For example, when hydrocarbon gas and water vapor are reformed at high temperature, not only hydrogen but also carbon monoxide CO, carbon dioxide CO₂, unreacted water vapor H₂O, and hydrocarbon, such as methane CH₄, are produced.

Thus, it becomes possible to efficiently purify or store hydrogen if there is a hydrogen permeation membrane or a hydrogen storage membrane that has a high selectivity with respect to the aforementioned gases such as carbon monoxide CO, carbon dioxide CO₂, water vapor H₂O), and methane CH₄. Gas separation membranes for separating hydrogen gas from other gases are required to have high gas permeability, and a high ability to separate hydrogen and other gases (such as methane). They are also required to have such properties that a membrane without defects, such as pin holes, can be easily made, and stable performance is obtained in the environment where it is used. They also need to withstand long-time use, have good resistance to pressure, can be constructed in modules, and have superior resistance to heat and chemicals. Conventionally, a palladium membrane is well known as a membrane that selectively allows hydrogen to permeate. Palladium, however, is very expensive, and because a palladium membrane is a thin film, it is not resistant to pressure and it also has chemical resistance problems. Furthermore, because palladium needs to be used in the form of a thin membrane, it is difficult to obtain desired shapes, for example.

Commercially available membranes of organic material include (Product name: cellulose acetate from Sepharex; Product name: polysulfone from Monsanto; Product name: polyimide from Ube Industries, Ltd.; polyamide from Dupont).

These are all glassy polymers having high glass transition temperatures, and their hydrogen permeation selectivity with respect to methane is reported to be in the range of 40 to 200 (see Non-patent Document 1, for example). With reference to a prism separator consisting of an asymmetrical polysulfone hollow-fiber composite membrane from Monsanto as mentioned above, gases can be arranged as follows in order of decreasing permeation rate: water vapor>hydrogen>helium>hydrogen sulfide>carbon dioxide>oxygen>argon>carbon monoxide>nitrogen>methane. Major gas molecules are arranged as follows in order of increasing size: helium<water vapor<hydrogen<carbon dioxide<oxygen<nitrogen<methane. Thus, the rate of permeation through a separation membrane is determined not only by the size of the molecule but it also varies depending on the properties of the material of the separation membrane.

A technique is also published (see Patent Document 1, for example) whereby silicon resin, which is a material used in the invention, is used in a hydrogen permeation membrane. The technique disclosed in this document involves the formation of a membrane having a hydrogen permeation function, such as a membrane of silicon resin, on a porous support to a membrane thickness of 500 microns or less. With this technique, however, it is difficult to obtain desired shapes, as in the case of palladium membrane, and it is also difficult to obtain modules or to achieve high resistance to pressure.

Regarding the processes for storing hydrogen, the existing technologies involving high-pressure hydrogen gas cylinders, liquefied hydrogen cylinders, hydrogen absorbing alloy, carbon material, organic material, and so on are currently used as hydrogen storage media. With reference to high-pressure hydrogen gas cylinders, for example, development is underway of high-pressure cylinders of 700 atmospheres for automobiles equipped with fuel cells. With reference to hydrogen absorbing alloy, studies on LaNi₅, for example, which is an alloy of lanthanum and nickel, are actively underway. One most suitable example of the utilization of the hydrogen storage and transfer technology is its application to hydrogen fuel tanks on fuel cell vehicles. Mobile media such as fuel cell vehicles require stable and safe supply of hydrogen to the cells. However, high-pressure cylinders have the danger of explosion or the like, while hydrogen absorbing alloy is capable of storing only a small amount of hydrogen per unit mass of the alloy. Thus, there are many problems to be overcome before these technologies can be put to practical use.

Non-patent Document 1: “Separation Engineering,” Advances in Chemical Engineering 25, edited by The Society of Chem. Engrs, Japan, Maki-shoten Patent Document 1: JP Patent Publication (Kokai) No. 2001-198431 A

### DISCLOSURE OF THE INVENTION

Problems to be Solved by the Invention

The aforementioned conventional hydrogen permeation membranes, hydrogen storage membranes, and processes for forming the same have the following problems. The hydrogen permeation mechanism of the palladium membrane involves a dissolution and diffusion mechanism accompanied by the dissociation of hydrogen. In order to increase the permeation rate up to the practical level, it would be necessary to either supply hydrogen gas at temperatures of 300° or higher and at several tens of pressures, or to reduce the membrane thickness to the order of several tens of microns. In addition, the palladium membrane, when coexisting with hydrogen, forms a kind of solid solution, the temperature of which would have to be increased to approximately 400° C. so as to increase the permeation rate. In other words, each time the hydrogen permeating function is realized, heating and cooling are repeated. As a result, due to the accumulation of internal stress caused by the repetition of two-phase separation into two phases with different hydrogen concentrations and the re-emergence of the state of solid solution, the membrane tends to break. For example, in the case of a thin membrane of palladium or an alloy thereof formed by plating, evaporation, sputtering or rolling, pin holes tend to be formed. In order to avoid this problem, silver or gold is often added to the palladium in the amount of approximately 25%. Other problems are the fact that palladium itself is very expensive, and that a thin membrane of palladium needs to be formed on the surface of a heat-resistant porous support.

Hydrogen, water vapor, and helium molecules have substantially the same size. For example, with regard to the hydrogen gas separation membrane to be used when reforming hydrocarbon with water vapor, the permeation rate of hydrogen needs to be sufficiently large as compared with that of water vapor. Thus, the membrane needs to have a practical level of hydrogen permeation selectivity, and it also needs to be easily formed, resistant to pressure, and sufficiently strong.

With regard to hydrogen storage material, there are many problems to be overcome in conventional hydrogen storing alloys, such as their high price, their weight due to the fact that they are alloys (namely, their storage amount per unit weight is small), the deterioration due to the repetition of storage and discharge (namely, pulverization or the change in structure of the alloy), and, in the case where the alloy includes a rare metal, the need to ensure its resource.

It is an object of the invention to overcome the aforementioned problems of the conventional art, and to provide a hydrogen or helium permeation membrane that substantially does not contain expensive metal having affinity with hydrogen. The membrane has superior pressure, heat, and chemical resistance and mechanical strength. It also has a high permeability with respect to hydrogen, the membrane further having the following properties: (1) it allows the passage of hydrogen more easily than water vapor; (2) it does not easily allow the passage of methane; and (3) it does not easily allow the passage of ammonium gas. The invention can be applied to a hydrogen separation membrane obtained by the reforming reaction of water vapor and hydrocarbon, to an external film of secondary cells such as lithium cells, and to a hydrogen permeation membrane used in electrolytic capacitors, fuel cells, and solar cell systems.

It is another object of the invention to provide a hydrogen permeation membrane such that the permeation ratio can be controlled by the baking temperature, membrane thickness, or through additives such as Aerosil, wherein the membrane is inexpensive and easy to manufacture, having a high degree of freedom in membrane thickness ranging from a thin membrane of several μm to a thick membrane of several mm, and wherein the membrane can be processed in any desired form, including tubes, sheets, bulk, and fiber (threads).

Another object of the invention is to provide a hydrogen storage membrane that does not have the aforementioned problems and that is capable of storing hydrogen under normal temperature and pressure conditions, allowing hydrogen to be handled safely. Such hydrogen storage membrane enhances the application of fuel cells as a power supply for electric vehicles to hydrogen storage tanks or the like.

Means for Solving the Problems

As a result of extensive research and study for solving the aforementioned problems, the inventors realized that by using, as a hydrogen permeation membrane that selectively allows the passage of hydrogen and that can be formed in any desired shape, a silicon resin containing at least phenylheptamethylcyclotetrasiloxane and/or 2,6-cis-diphenylhexamethylcyclotetrasiloxane, a coating that is resistant to 300° C. or higher can be obtained in a sintering process with heat treating temperature of 200° C. to 500° C., whereby a hydrogen permeation membrane having excellent water resistance can be obtained. The invention is based on such realization.

Similarly, the inventors arrived at the invention after realizing that, by using, as a hydrogen permeation membrane that selectively stores hydrogen and that can be formed in any desired shape, a silicon resin containing at least phenylheptamethylcyclotetrasiloxane and/or 2,6-cis-diphenylhexamethylcyclotetrasiloxane, a coating resistant to 300° C. or higher can be obtained in a sintering process with heat treating temperature of 200° C. to 500° C., whereby a hydrogen storage membrane having excellent water resistance can be obtained.

Namely, the invention is directed to the following:

1) A hydrogen or helium permeation membrane comprising a silicon resin that includes at least phenylheptamethylcyclotetrasiloxane and/or 2,6-cis-diphenylhexamethylcyclotetrasiloxane.

2) The hydrogen or helium permeation membrane according to claim 1, wherein the silicon resin that includes at least phenylheptamethylcyclotetrasiloxane and/or 2,6-cis-diphenylhexamethylcyclotetrasiloxane contains a metal or oxide particle.

3) The hydrogen or helium permeation membrane according to claim 2, wherein the metal or oxide particle comprises a particle or ultrafine particle of Al, Ti, Si, Ag, or the like, a filler comprising a particle of alumina, titanium oxide, SiO₂, or the like, and an ultrafine particle silica or the like.

4) The hydrogen or helium permeation membrane according to any one of claims 1 to 3, wherein the hydrogen permeation membrane is thermally cured at temperature of 200° C. to 500° C. after being adjusted to a desired viscosity at temperature of 230° C. or lower into a precursor.

5) The hydrogen or helium permeation membrane according to claim 4, wherein the precursor and the hydrogen permeation membrane are subjected to a vacuum heating process at least once at a temperature lower than or equal to a temperature at which the hydrogen permeation membrane is cured.

6) A method for forming a hydrogen or helium permeation membrane comprising the steps of:

causing a metal or oxide particle to be contained in a silicon resin that includes at least phenylheptamethylcyclotetrasiloxane and/or 2,6-cis-diphenylhexamethylcyclotetrasiloxane, to which resin a metal or oxide particle is contained, and then forming a precursor having a desired viscosity at temperature of 230° C. r lower; and

thermally curing the precursor at temperature of 200° C. to 500° C.

7) The method for forming a hydrogen or helium permeation membrane according to claim 6, wherein the metal or oxide particle comprises a particle or ultrafine particle of Al, Ti, Si, Ag, or the like, a filler comprising a particle of alumina, titanium oxide, SiO₂, or the like, and an ultrafine particle silica or the like.

8) The method for forming a hydrogen or helium permeation membrane according to claim 7, wherein the step of forming the precursor and the hydrogen or helium permeation membrane comprises performing a vacuum thermal process at least once at a temperature lower than equal to a temperature at which the hydrogen or helium permeation membrane is cured.

9) A hydrogen or helium storage membrane comprising a silicon resin that includes at least phenylheptamethylcyclotetrasiloxane and/or 2,6-cis-diphenylhexamethylcyclotetrasiloxane.

10) The hydrogen or helium storage membrane according to claim 9, wherein the silicon resin that includes at least phenylheptamethylcyclotetrasiloxane and/or 2,6-cis-diphenylhexamethylcyclotetrasiloxane comprises a metal or oxide particle.

11) The hydrogen or helium storage membrane according to claim 10, wherein the metal or oxide particle comprises a particle or ultrafine particle of Al, Ti, Si, Ag, or the like, a filler comprising a particle of alumina, titanium oxide, SiO₂, or the like, and an ultrafine particle silica or the like.

12) The hydrogen or helium storage membrane according to claim 10 or 11, wherein the hydrogen storage membrane is thermally cured at temperature of 200° C. to 500° C. after being adjusted to a desired viscosity at temperature of 230° C. or lower into a precuror.

13) The hydrogen or helium storage membrane according to claim 10, wherein the precursor and the hydrogen or helium storage membrane is subjected to a vacuum heating process at least once at a temperature lower than or equal to a temperature at which the hydrogen or helium storage membrane is cured.

14) A method for forming a hydrogen or helium storage membrane comprising the steps of:

forming a precursor having a desired viscosity at a temperature of 230° C. from either a silicon resin that includes at least phenylheptamethylcyclotetrasiloxane and/or 2,6-cis-diphenylhexamethylcyclotetrasiloxane, or silicon resin that includes at least phenylheptamethylcyclotetrasiloxane and/or 2,6-cis-diphenylhexamethylcyclotetrasiloxane, to which resin a metal or oxide particle is contained; and

thermally curing the precursor at temperature of 200° C. to 500° C.

15) The method for forming a hydrogen or helium storage membrane according to claim 10, wherein the metal or oxide particle comprises a particle or ultrafine particle of Al, Ti, Si, Ag, or the like, a filler comprising a particle of alumina, titanium oxide, SiO₂, or the like, and an ultrafine particle silica or the like.

16) The method for forming a hydrogen or helium storage membrane according to claim 10, wherein the step of forming a hydrogen or helium storage membrane comprises performing a vacuum heating process at least once at a temperature lower than or equal to a temperature at which the hydrogen or helium storage membrane is cured.

Effects of the Invention

As will be apparent from the above, in accordance with the invention, a hydrogen or helium permeation membrane having a desired membrane thickness of 1 μm or less to several mm and having pressure resistance, heat resistance of 300° C. or higher, and excellent chemical resistance can be easily formed by using a precursor comprised of a silicon resin containing at least phenylheptamethylcyclotetrasiloxane and/or 2,6-cis-diphenylhexamethylcyclotetrasiloxane.

Further, in accordance with the invention, a precursor paste is obtained of which the viscosity is adjusted at a temperature of 230° C. or lower to a desired level. The precursor paste is thermally cured at temperature of 200° C. to 500° C. After conducting a vacuum heating process at least once at temperature lower than a temperature at which the hydrogen permeation membrane is cured, the precursor paste is formed in a desired shape. In this way, a hydrogen or helium permeation membrane that does not have many cracks, much warping, or interlayer peeling or the like can be easily prepared.

Further, in accordance with the invention, by adjusting the viscosity as needed by appropriately selecting and setting the temperature and time, a hydrogen or helium permeation membrane having a desired performance can be formed.

The permeation membrane of the invention allows the passage of hydrogen gas with high selectivity in the presence of water and gases that are produced as by-products in the course of hydrogen manufacturing process, such as carbon monoxide, carbon dioxide, methane, ammonium, and the like. In addition, the permeation membrane has excellent heat resistance and chemical resistance, and it can be used for applications at temperature of 300° C. or higher.

Further, the hydrogen or helium storage membrane of the invention is capable of storing hydrogen with high efficiency under room temperature and pressure conditions. Thus, application of the hydrogen or helium storage membrane to a hydrogen fuel tank or the like of fuel cells as the power supply for electric vehicles can be enhanced, thus providing great benefits.

### BRIEF DESCRIPTION OF THE DRAWINGS

FIG. 1 shows a cross section (a) and a plan view (b) of an example of a hydrogen permeation membrane of the invention.

FIG. 2 shows a cross section (a) and a plan view (b) of an example of a hydrogen storage membrane of the invention.

FIG. 3 shows a schematic plan view of a vacuum apparatus for defoaming a precursor.

FIG. 4 shows a schematic side view of an apparatus for measuring the presence or absence of permeation or storage of hydrogen.

FIG. 5 shows a schematic side view of an apparatus for measuring the presence or absence of permeation or storage of hydrogen.

### BEST MODES FOR CARRYING OUT THE INVENTION

The invention is described in detail in the following.

(Hydrogen or Helium Permeation Membrane)

The hydrogen or helium permeation membrane used in the invention employs, as raw material, phenylheptamethylcyclotetrasiloxane and/or 2,6-cis-diphenylhexamethylcyclotetrasiloxane, and silicon resin. Their stock solutions, or their solutions in an organic solvent such as toluene or xylene, are prepared, and their viscosity is adjusted for the membrane thickness and the coating method used, so as to prepare a precursor. Further, stock solutions of phenylheptamethylcyclotetrasiloxane, 2,6-cis-diphenylhexamethylcyclotetrasiloxane and silicon resin as raw material, or their solutions in an organic solvent such as toluene or xylene, are prepared, and a filler consisting of ultrafine powder silica, oxide particles of e.g. alumina or titanium, and SiO₂ fine particles is added. After adjusting the viscosity, a precursor is prepared.

In the case of membrane thickness on the order of several μm or less, the viscosity is adjusted to several cps to 100 cps. In the case of membrane thickness of several μm or more, heating is further conducted at 60 to 150° C. for 2 to 5 hours such that condensation reaction proceeds while the solvent is evaporated. Further, while evacuating in a vacuum chamber, a defoaming process is conducted in reduced pressure of 100 Pa to 1 Pa, and the viscosity of the reaction product is adjusted to 100 cps to 10000 cps, thereby obtaining a precursor paste.

The thus viscosity-adjusted precursor is cast-molded into a desired shape by a known method such as one involving a dispenser, spraying, or screen printing, for example. The molded product is then heated in the atmosphere at 350° C. so as to allow a hydrogen or helium permeation membrane to be cured. The degree of vacuum during the defoaming process is preferably on the order of several Pa. However, the vacuum may be on the order of several thousand Pa or it may be high vacuum on the order of 10 to 3 Pa, if under reduced pressure. Preferably, the temperature for the formation of precursors and the temperature for defoaming are approximately 120° from the safety point of view. However, the temperatures may be such that the hydrogen or helium permeation membrane does not become cured. The curing temperature is preferably from 350° to 450°; however, it may range from 200° C. to 500° C. as long as curing can be achieved.

While ultrafine particle silica (such as Aerosil from Degussa, for example), and fine-powder metal oxides such as TiO₂, SiO₂, Al₂O₃ are added to the silicon resin, the invention is not limited to these metal oxides. Metals such as In, Ti, Ag and Ru or alloys thereof are also effective, and their particle size can be appropriately selected depending on applications.

(Hydrogen or Helium Storage Membrane)

The hydrogen or helium permeation membrane used in the invention employs, as raw material, phenylheptamethylcyclotetrasiloxane and/or 2,6-cis-diphenylhexamethylcyclotetrasiloxane, and silicon resin. Their stock solutions, or their solutions in an organic solvent such as toluene or xylene, are prepared, and their viscosity is adjusted for the membrane thickness and the coating method used, so as to prepare a precursor. Further, stock solutions of phenylheptamethylcyclotetrasiloxane, 2,6-cis-diphenylhexamethylcyclotetrasiloxane, and silicon resin as raw material, or their solutions in an organic solvent such as toluene or xylene, are prepared, and a filler consisting of ultrafine powder silica, oxide particles of e.g. alumina or titanium, and SiO₂ fine particles is added. After adjusting the viscosity, a precursor is prepared.

In the case of membrane thickness on the order of several μm or less, the viscosity is adjusted to several cps to 100 cps. In the case of membrane thickness of several μm or more, heating is further conducted at 60 to 150° C. for 2 to 5 hours such that condensation reaction proceeds while the solvent is evaporated. Further, while evacuating in a vacuum chamber, a defoaming process is conducted in reduced pressure of 100 Pa to 1 Pa, and the viscosity of the reaction product is adjusted to 100 cps to 10000 cps, thereby obtaining a paste precursor.

The thus viscosity-adjusted precursor is cast-molded into a desired shape by a known method such as one involving a dispenser, spraying, or screen printing, for example. The molded product is then heated in the atmosphere at 300° C. so as to allow a hydrogen or helium storage membrane to be cured. The degree of vacuum during the defoaming process is preferably on the order of several Pa. However, the vacuum may be on the order of several thousand Pa or it may be high vacuum on the order of 10 to 3 Pa, if under reduced pressure. Preferably, the temperature for the formation of precursors and the temperature for defoaming are approximately 120° from the safety point of view. However, the temperatures may be such that the hydrogen storage membrane does not become cured. The curing temperature is preferably from 350° to 450°; however, it may range from 200° C. to 500° C. as long as curing can be achieved.

While ultrafine particle silica (such as Aerosil from Degussa, for example), and fine-powder metal oxides such as TiO₂, SiO₂, Al₂0₃ are added to the silicon resin, the invention is not limited to these metal oxides. Metals such as In, Ti, Ag and Ru or alloys thereof are also effective, and their particle size can be appropriately selected depending on applications.

The hydrogen or helium storage membrane used in the invention can be formed by forming the hydrogen storage membrane on a glass substrate or metal substrate that does not allow the passage of hydrogen, or by forming, by vapor deposition or plating, a metal that does not allow the passage of hydrogen on a part of the hydrogen permeation membrane prepared in a desired shape.

### EXAMPLES

While the invention will be described in the following by way of preferable examples, the invention is not limited to these examples, and various substitution of elements, design changes, or changes in the order of the steps may be made to the extent the purpose of the invention can be achieved. Membrane thickness and membrane quality were observed with an electron microscope (FE-SEM(S-4000) from Hitachi Ltd.). With regard to the degree of freedom of membrane thickness, “Good” indicates those cases where membrane thickness can be controlled widely by changing factors, such as viscosity, in accordance with the processing method for forming the hydrogen permeation membrane and hydrogen storage membrane, while “Bad” indicates those cases where the controllable range is narrow (Table 1).

### Example 1

1 g of phenylheptamethylcyclotetrasiloxane and 59 g of silicon resin were dissolved in 40 g of toluene. The solution was then put in a mold of Teflon (registered trademark; the same applies hereunder), and sintered in the atmosphere in a baking furnace at 230° C. As a result, a hydrogen permeation membrane of the invention measuring 100 mm×100 mm and having a thickness of 1 μm was obtained.

### Example 2

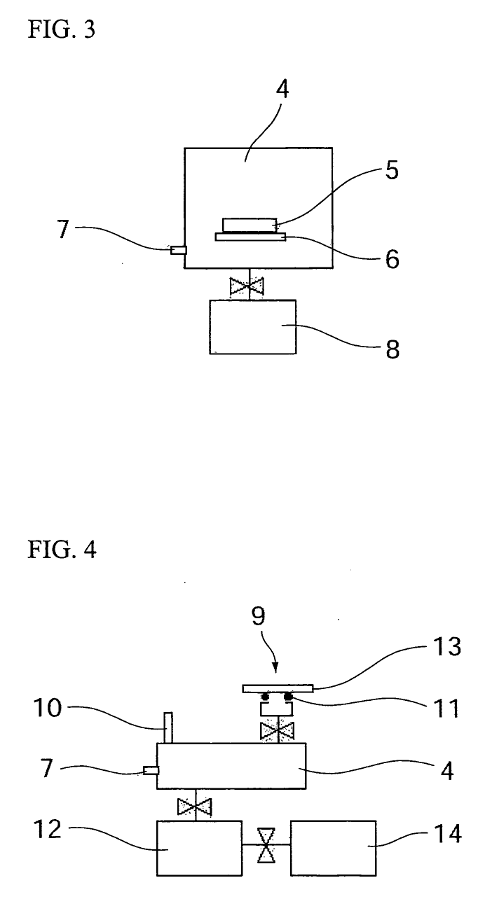

1 g of phenylheptamethylcyclotetrasiloxane and 59 g of silicon resin were dissolved in 40 g of toluene. While heating at 100° C., the toluene was evaporated and a condensation reaction was conducted for about 2 hours. Thereafter, the precursor was placed on a hot plate in a vacuum chamber, and evacuation was conducted while the hot plate was heated (see FIG. 3). At the vacuum in the vacuum chamber of approximately 100 Pa and the temperature of the hot plate of 140° C., a defoaming process was conducted for 10 min. Then, while the hot plate was cooled, the atmosphere was returned to room air, thereby obtaining a precursor paste having a viscosity of several hundred cps. The precursor paste was then applied to a Teflon plate by screen printing to the size of 100 mm×100 mm, which was then put in a baking furnace where it was sintered in the atmosphere at 230° C. After a sheet-like product was once removed from the Teflon, the precursor was once again put in the firing furnace where it was sintered in the atmosphere at 300° C. As a result, a sheet-like hydrogen permeation membrane with a thickness of 20 μm was obtained that did not have many cracks.

### Example 3

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. Using this solution, a hydrogen permeation membrane having a thickness of 1 μm was obtained in the same way as in Example 1.

### Example 4

0.1 g of phenylheptamethylcyclotetrasiloxane, 0.1 of 2,6-cis-diphenylhexamethylcyclotetrasiloxane, and 59.8 g of silicon resin were dissolved in 40 g of toluene. While heating at 120° C., the toluene was evaporated and a condensation reaction was conducted for about 3 h, thereby obtaining a precursor. Thereafter, the reaction product, that is the precursor, was placed on a hot plate in a vacuum chamber where evacuation was conducted while the hot plate was heated. At the vacuum in the vacuum chamber of approximately 1 Pa and the temperature of the hot plate 7 of 140° C., a defoaming process was conducted for 60 min. Then, while the hot plate was cooled, the atmosphere was returned to room air, thereby obtaining a precursor paste having a viscosity of several hundred cps. The precursor paste was then re-heated to 100° C. and then placed in a dispenser. After applying to a mold of Teflon measuring 1 mm in width×100 mm in length×20 μm in depth, it was put in a baking furnace where it was sintered in the atmosphere at 200° C. After the applied product was once removed from the Teflon, the applied product was once again put in the firing furnace where it was sintered in the atmosphere at 450° C. As a result, a linear hydrogen permeation membrane with a thickness of 20 μm was obtained that had no cracks.

### Example 5

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. While heating at 120° C., the toluene was evaporated and a condensation reaction was conducted for about 3 h, thereby obtaining a precursor. Thereafter, the reaction product, that is the precursor, was placed on a hot plate in a vacuum chamber where evacuation was conducted while the hot plate was heated. At the vacuum in the vacuum chamber of approximately 1 Pa and the temperature of the hot plate of 140° C., a defoaming process was conducted for 60 min. Then, while the hot plate was cooled, the atmosphere was returned to room air, thereby obtaining a precursor paste having a viscosity of several hundred cps. The precursor paste was then applied to the entire surface of a Teflon sheet with a thickness of 1 mm by printing. It was then placed in a baking furnace where it was formed in a flat sheet in the atmosphere at 230° C. with a Teflon sheet placed on top. After removing the top and bottom Teflon, the resultant sheet material was sintered at 450° C., thereby obtaining a sheet-like hydrogen permeation membrane with a thickness of 1 mm that had no cracks.

### Example 6

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. Then, a hydrogen permeation membrane was obtained in the same way as in Example 5 with the exception that 2 g of ultrafine powder silica (Aerosil from Degussa) was added.

### Example 7

1 g of phenylheptamethylcyclotetrasiloxane and 59 g of silicon resin were dissolved in 40 g of toluene. After applying this solution to both surfaces of a copper plate by the dipping method, the copper plate was put in a baking furnace in which it was sintered in the atmosphere at 300° C., thereby obtaining a hydrogen storage membrane measuring 100 mm×100 mm with a thickness of 1 μm.

### Example 8

1 g of phenylheptamethylcyclotetrasiloxane and 59 g of silicon resin were dissolved in 40 g of toluene. While heating at 100° C., the toluene was evaporated and a condensation reaction was conducted for about 2 h. Thereafter, the reaction product, that is a precursor, was placed on a hot plate in a vacuum chamber where evacuation was conducted while the hot plate was heated. At the vacuum in the vacuum chamber of approximately 100 Pa and the temperature of the hot plate of 140° C., a defoaming process was conducted for 10 min. Then, while the hot plate was cooled, the atmosphere was returned to room air, thereby obtaining a precursor paste having a viscosity of several hundred cps. The precursor paste was then applied to a SUS plate by screen printing to a size measuring 100 mm. The plate was then placed in a baking furnace where it was sintered in the atmosphere at 300° C., thereby obtaining a SUS plate-like hydrogen storage membrane on which a membrane with a thickness of 20 μm was formed that had no cracks.

### Example 9

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. The solution was processed in the same way as in Example 1, thereby obtaining a hydrogen storage membrane with a thickness of 1 μm.

### Example 10

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. While heating at 120° C., the toluene was evaporated and a condensation reaction was conducted for about 3 h so as to prepare a precursor. Thereafter, the reaction product, that is the precursor, was placed on a hot plate in a vacuum chamber where evacuation was conducted while the hot plate was heated. At the vacuum in the vacuum chamber of approximately 1 Pa and the temperature of the hot plate of 140° C., a defoaming process was conducted for 60 min. Then, while the hot plate was cooled, the atmosphere was returned to room air, thereby obtaining a precursor paste having a viscosity of several hundred cps. The precursor paste was then re-heated to 100° C. and then put in a dispenser. After applying it to a glass plate to a shape measuring 1 mm in width, 100 mm in length, and 20 μm in depth, the glass plate was put in a baking furnace where it was sintered in the atmosphere at 450° C., thereby obtaining a linear hydrogen storage membrane with a thickness of 20 μm that had no cracks.

### Example 11

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. While heating at 120° C., the toluene was evaporated and a condensation reaction was conducted for about 3 h to prepare a precursor. Thereafter, the reaction product, that is the precursor, was placed on a hot plate in a vacuum chamber where evacuation was conducted while the hot plate was heated. At the vacuum in the vacuum chamber of approximately 1 Pa and the temperature of the hot plate of 140° C., a defoaming process was conducted for 60 min. Then, while the hot plate was cooled, and the atmosphere was returned to room air, thereby obtaining a precursor paste having a viscosity of several hundred cps. The precursor paste was then applied to the entire surface of a Teflon sheet with a thickness of 1 mm by printing. The sheet was then placed in a baking furnace where the paste was formed in a flat sheet in the atmosphere at 230° C. with a Teflon sheet placed on top. After removing the top and bottom Teflon, the resultant sheet material was sintered at 450° C., thereby obtaining a sheet-like membrane with a thickness of 1 mm that had no cracks. Thereafter, an aluminum membrane was formed only on one surface of the sheet by ion beam sputtering deposition to a thickness of 100 nm, thereby obtaining a hydrogen storage membrane.

### Example 12

0.1 g of phenylheptamethylcyclotetrasiloxane, 0.1 g of 2,6-cis-diphenylhexamethylcyclotetrasiloxane, and 59.8 g of silicon resin were dissolved in 40 g of toluene. The solution was processed in the same way as in Example 11 with the exception that 20 g of an SiO₂ filler having an average particle size of 30 μm was added to the solution, thereby obtaining a hydrogen storage membrane of the invention.

TABLE 1

| | | | | | Property |
|---|---|---|---|---|---|
| | | | | Membrane | (Transmission/ |
| | Membrane | | | quality(lack | storage of |
| | thickness | | Membrane thickness range | of e.g. cracks) | hydrogen) |
| Example 1 | 1 | μm | 0.1 to several μm | Good | Good |
| Example 2 | 20 | μm | 1 to several tens μm | Good | Good |
| Example 3 | 1 | μm | 0.1 to several μm | Good | Good |
| Example 4 | 100 | μm | Several tens to several | Good | Good |
| | | | hundred μm | | |
| Example 5 | 1 | mm | 0.3 mm to 2 mm | Good | Good |
| Example 6 | 1 | mm | 0.3 mm to 2 mm | Good | Good |
| Example 7 | 1 | μm | 0.1 to several μm | Good | Good |
| Example 8 | 20 | μm | 1 to several tens μm | Good | Good |
| Example 9 | 1 | μm | 0.1 to several μm | Good | Good |
| Example 10 | 20 | μm | 1 to several tens μm | Good | Good |
| Example 11 | 1 | mm | 0.3 mm to 2 mm | Good | Good |
| Example 12 | 1 | mm | 0.3 mm to 2 mm | Good | Good |

### Example 13

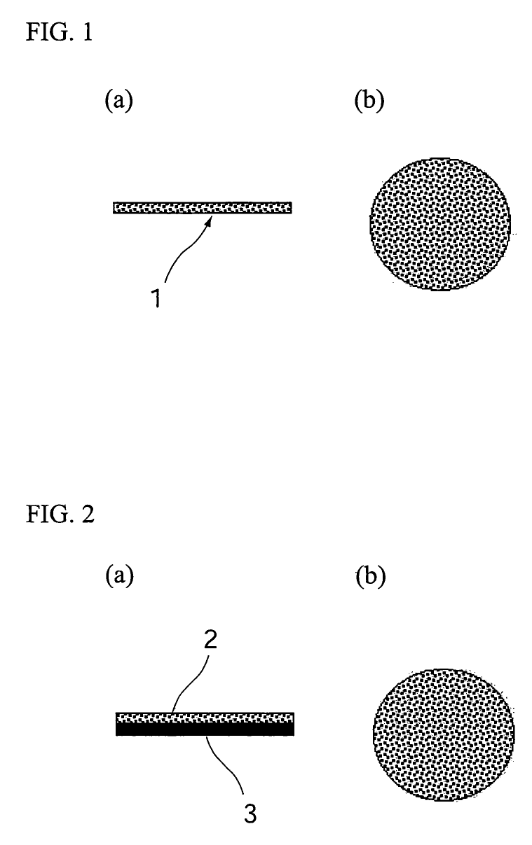

FIG. 1 shows a hydrogen permeation membrane 1 obtained in accordance with the invention. Hydrogen permeability of the hydrogen permeation membrane was verified with a differential pressure of 10 kPa. Table 2 shows the results for samples A, B, C, and a piece of stainless steel. It can be seen that hydrogen gas permeated the hydrogen permeation membrane of the invention and reached the concentration of 50 ppm or more within 2 seconds at the earliest and within 60 seconds at the latest. It was also verified that the permeability of the hydrogen permeation membrane obtained in accordance with the invention can be controlled by changing the thickness of the membrane or the components thereof.

TABLE 2

| | | | Hydrogen | | | |
|---|---|---|---|---|---|---|
| | Average | | concentration at (16) of | | | |
| | membrane | | FIG. 1 (units: ppm) | | | |
| Sample | thickness | Compo- | 2 sec | 10 sec | 60 sec | Perme- |
| name | (units: mm) | nents | later | later | later | ability |
| Sample A | 0.6 | I | 520 | OVER | OVER | Very |
| | | | | | | good |
| Sample B | 1.5 | II | 20 | 55 | 250 | Good |
| Sample C | 1.5 | III | (5) | (15) | 75 | Poor |
| Stainless | 0.1 | — | (2) | (5) | (5) | Bad |
| piece | | | | | | |

*Notes regarding the hydrogen concentration of a hydrogen sensor:
Effective detection concentration: 20 ppm or higher.
Detection upper-limit (OVER): 2000 ppm or higher
Response time: 20 seconds or less.

### Example 14

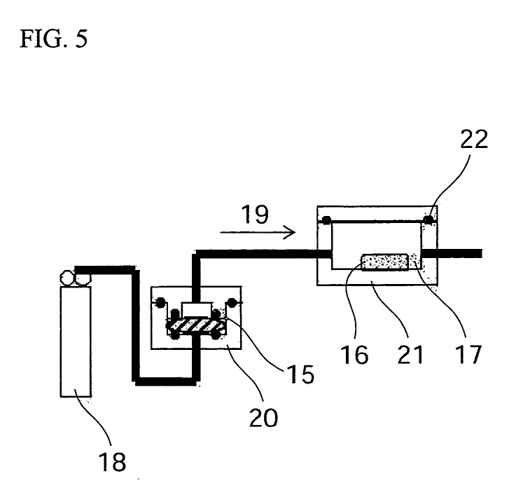

FIG. 1 shows a hydrogen permeation membrane 1 obtained in accordance with the invention. Permeability of the hydrogen permeation membrane was evaluated for a variety of gases (oxygen, methane, carbon monoxide, carbon dioxide, and water vapor) while portions of FIG. 1 that will be indicated later were changed. The changed portions in FIG. 1 include a hydrogen sensor 17 shown in FIG. 5 that was sequentially changed to an oxygen sensor, methane sensor, carbon monoxide sensor, carbon dioxide sensor, and water vapor detector. Similarly, the mixture gas 18 was sequentially changed to oxygen-containing gas, methane-containing gas, carbon monoxide-containing gas, carbon dioxide-containing gas, and a dew point meter, and it was determined whether or not these gases were permeated. Permeation of these gases were all below detection limits. Table 3 shows the results for sample A and a piece of stainless steel.

It was thus verified that the hydrogen permeation membrane obtained in accordance with the invention hardly allows the passage of a variety of gases that could possibly be permeated, thus verifying the selective hydrogen permeability of the hydrogen permeation membrane.

TABLE 3

| | | | | Concentration of various | | | |
|---|---|---|---|---|---|---|---|
| | Avg. | | Name | gases of FIG. 16 at 1 (units: | | | |
| | membrane | | of gas | ppm) | | | |
| Sample | thickness | | and | 2 sec | 10 sec | 60 sec | |
| name | (units: mm) | Components | sensor | later | later | later | Permeability |
| Sample A | 0.6 | I | oxygen | <10 | <10 | <10 | Bad |
| Stainless | 0.1 | — | oxygen | <10 | <10 | <10 | Bad |
| piece | | | | | | | |
| Sample A | 0.6 | I | methane | <10 | <10 | <10 | Bad |
| Stainless | 0.1 | — | methane | <10 | <10 | <10 | Bad |
| piece | | | | | | | |
| Sample A | 0.6 | I | carbon | <5 | <5 | <5 | Bad |
| | | | monoxide | | | | |
| Stainless | 0.1 | — | carbon | <5 | <5 | <5 | Bad |
| piece | | | monoxide | | | | |
| Sample A | 0.6 | I | carbon | <10 | <10 | <10 | Bad |
| | | | dioxide | | | | |
| Stainless | 0.1 | — | carbon | <10 | <10 | <10 | Bad |
| piece | | | dioxide | | | | |
| Sample A | 0.6 | I | water | <10 | <10 | <10 | Bad |
| Stainless | 0.1 | — | vapor | <10 | <10 | <10 | Bad |
| piece | | | dew | | | | |
| | | | point | | | | |
| | | | meter | | | | |

* Effective detection concentration of oxygen sensor: 10 ppm or higher
* Effective detection concentration of methane sensor: 10 ppm or higher
* Effective detection concentration of carbon monoxide sensor: 5 ppm or higher
* Effective detection concentration of carbon dioxide sensor: 10 ppm or higher
* Effective detection concentration of dew point meter: 10 ppm or higher

### Example 15

Presence or absence of hydrogen permeation in the hydrogen permeation membrane was measured using an apparatus shown in FIG. 4.

A vacuum apparatus to which a Q-mass (quadrupole mass spectrometer) 10 was attached was evacuated while the prepared hydrogen permeation was pressed against a part of the evacuation apparatus via an O ring 11 that was dimensioned in accordance with the size of the membrane. When the vacuum dropped below 10⁻⁴ Pa, a filament of the Q-mass was attached, and the gas in the chamber 4 was measured. Thereafter, the sheet was blown with a minute volume of dry air, and it was confirmed that the mass of the H₂(2),N₂(28), O₂(32), and Ar(39) did not increase. Then, the sheet was similarly blown with high-purity argon gas containing 2% of hydrogen (2) so as to confirm the presence or absence of permeation of hydrogen based on the increase in H₂(2) alone.

It was confirmed that the sheet-like membranes according to Examples 1, 2, 3, 5, and 6 allowed the permeation of hydrogen. It was possible to evacuate without causing the sheet to be broken, cracked, or warped and destroyed by the atmospheric pressure resistance. Thus, it was shown that the hydrogen permeation membranes used in the Examples did not have pinholes that would pose an obstacle to evacuation.

### Example 16

Using the apparatus of FIG. 4, the performance of the hydrogen storage membrane of the invention was examined. The prepared hydrogen storage membrane was set on the vacuum apparatus, and the apparatus was evacuated. When the vacuum dropped below 10⁻⁴ Pa, a filament of the Q-mass 10 was attached, and the gas in the chamber 4 was measured so as to measure the hydrogen background level (“BG”). The apparatus was then encased in a bag that did not pass hydrogen, and the bag was filled with high-purity argon gas containing 2% of hydrogen (2), thus exposing the apparatus to the hydrogen-containing atmosphere. After exposure for a desired duration of time, the bag was removed and the vicinity of the hydrogen permeation membrane was blown with dry air so as to blow away the hydrogen-containing atmosphere gas. By comparing an Al plate or an SUS plate in which no hydrogen was stored with the hydrogen permeation membrane of the invention, and by measuring the level by which only H2(2) had increased from the BG level as well as the duration of time in which it was possible to determine that hydrogen was detected, the presence or absence of the storage of hydrogen was determined.

It was confirmed that hydrogen was stored in Examples 6 to 11. The sheet did not crack, break, or warped and destroyed by atmospheric pressure resistance. Particularly, it was possible to evacuate a membrane with a thickness of several tens of μm or greater.

1. A hydrogen or helium permeation membrane comprising a silicon resin that includes at least one of phenylheptamethylcyclotetrasiloxane and 2,6-cis-diphenylhexamethylcyclotetrasiloxane.

2. The hydrogen or helium permeation membrane according to claim 1, wherein the silicon resin that includes at least one of phenylheptamethylcyclotetrasiloxane and 2,6-cis-diphenylhexamethylcyclotetrasiloxane contains a metal or oxide particle.

3. The hydrogen or helium permeation membrane according to claim 2, wherein the metal or oxide particle comprises a particle or ultrafine particle including at least one of Al,Ti,Si, and Ag, a filler comprising a particle of alumina, titanium oxide, SiO₂, or the like, and an ultrafine particle silica or the like.

4. The hydrogen or helium permeation membrane according to claim 1, wherein the hydrogen permeation membrane is thermally cured at temperature of 200° C. to 500° C. after being adjusted to a desired viscosity at temperature of 230° C. or lower into a procurser.

5. The hydrogen or helium permeation membrane according to claim 4, wherein the precursor and the hydrogen permeation membrane are subjected to a vacuum heating process at least once at a temperature lower than or equal to a temperature at which the hydrogen permeation membrane is cured.

6. A method for forming a hydrogen or helium permeation membrane comprising the steps of:
causing a metal or oxide particle to be contained in a silicon resin that includes at least one of phenylheptamethylcyclotetrasiloxane and 2,6-cis-diphenylhexamethylcyclotetrasiloxane, or a silicon resin that includes at least one of phenylheptamethylcyclotetrasiloxane and 2,6-cis-diphenylhexamethylcyclotetrasiloxane, and then forming a precursor having a desired viscosity at temperature of 230° C. or lower; and
thermally curing the precursor at temperature of 200° C. to 500° C.

7. The method for forming a hydrogen or helium permeation membrane according to claim 6, wherein the metal or oxide particle comprises a particle or ultrafine particle including at least one of Al, Ti, Si, and Ag, a filler comprising a particle of alumina, titanium oxide, SiO₂, or the like, and an ultrafine particle silica or the like.

8. The method for forming a hydrogen or helium permeation membrane according to claim 7, wherein the step of forming the precursor and the hydrogen or helium permeation membrane comprising performing a vacuum thermal process at least once at a temperature lower than or equal to a temperature at which the hydrogen or helium permeation membrane is cured.

9. A hydrogen or helium storage membrane comprising a silicon resin that includes at least one of phenylheptamethylcyclotetrasiloxane and 2,6-cis-diphenylhexamethylcyclotetrasiloxane.

10. The hydrogen or helium storage membrane according to claim 9, wherein the silicon resin that includes at least one of phenylheptamethylcyclotetrasiloxane and 2,6-cis-diphenylhexamethylcyclotetrasiloxane comprises a metal or oxide particle.

11. The hydrogen or helium storage membrane according to claim 10, wherein the metal or oxide particle comprises a particle or ultrafine particle including at least one of Al, Ti, Si, and Ag, a filler comprising a particle of alumina, titanium oxide, SiO₂, or the like, and an ultrafine particle silica or the like.

12. The hydrogen or helium storage membrane according to claim 10, wherein the hydrogen storage membrane is thermally cured at temperature of 200° C. to 500° C. after being adjusted to a desired viscosity at temperature of 230° C. or lower into a precursor.

13. The hydrogen or helium storage membrane according to claim 10, wherein the precursor and the hydrogen or helium storage membrane is subjected to a vacuum heating process at least once at a temperature lower than or equal to a temperature at which the hydrogen or helium storage membrane is cured.

14. A method for forming a hydrogen or helium storage membrane comprising the steps of:
forming a precursor having a desired viscosity at a temperature of 230° C. or lower from either a silicon resin that includes at least one of phenylheptamethylcyclotetrasiloxane and 2,6-cis-diphenylhexamethylcyclotetrasiloxane, or a silicon resin that includes at least one of phenylheptamethylcyclotetrasiloxane and 2,6-cis-diphenylhexamethylcyclotetrasiloxane, to which resin a metal or oxide particle is contained; and
thermally curing the precursor at temperature of 200° C. to 500° C.

15. The method for forming a hydrogen or helium storage membrane according to claim 14, wherein the metal or oxide particle comprises a particle or ultrafine particle including at least one of Al, Ti, Si, and Ag, a filler comprising a particle of alumina, titanium oxide, SiO₂, or the like, and an ultrafine particle silica or the like.

16. The method for forming a hydrogen or helium storage membrane according to claim 15, wherein the step of forming a hydrogen or helium storage membrane comprises performing a vacuum heating process at least once at a temperature lower than or equal to a temperature at which the hydrogen or helium storage membrane is cured.

17. The hydrogen or helium permeation membrane according to claim 2, wherein the hydrogen permeation membrane is thermally cured at temperature of 200° C. to 500° C. after being adjusted to a desired viscosity at temperature of 230° C. or lower into a procurser.

18. The hydrogen or helium permeation membrane according to claim 3, wherein the hydrogen permeation membrane is thermally cured at temperature of 200° C. to 500° C. after being adjusted to a desired viscosity at temperature of 230° C. or lower into a procurser.

19. The hydrogen or helium permeation membrane according to claim 17, wherein the precursor and the hydrogen permeation membrane are subjected to a vacuum heating process at least once at a temperature lower than or equal to a temperature at which the hydrogen permeation membrane is cured.

20. The hydrogen or helium permeation membrane according to claim 18, wherein the precursor and the hydrogen permeation membrane are subjected to a vacuum heating process at least once at a temperature lower than or equal to a temperature at which the hydrogen permeation membrane is cured.

21. The hydrogen or helium storage membrane according to claim 11, wherein the hydrogen storage membrane is thermally cured at temperature of 200° C. to 500° C. after being adjusted to a desired viscosity at temperature of 230° C. or lower into a precursor.
